(19) United States
(12) Patent Application Publication
(10) Pub. No.: US 2026/0274224 A1
(43) Pub. Date: Sep. 17, 2026

(54) METHOD FOR OPERATING A MOTOR VEHICLE, MOTOR VEHICLE, AND COMPUTER PROGRAM PRODUCT

(71) Applicant: AUDI AG, Ingolstadt (DE)

(72) Inventor: Ulrich TREFFER, Neustadt a. d. Donau (DE)

(73) Assignee: AUDI AG, Ingolstadt (DE)

(21) Appl. No.: 18/872,369

(22) PCT Filed: Jun. 1, 2023
(86) PCT No.: PCT/EP2023/064646

§ 371 Date: Dec. 6, 2024

(30) Foreign Application Priority Data
Jul. 26, 2022 (DE) 10 2022 118 674.1

(51) Int. Cl. B60T 8/26; B60T 8/171; B60T 8/172; B60T 8/58

(52) U.S. Cl. CPC B60T 8/26; B60T 8/171; B60T 8/172; B60T 8/58; B60T 2210/20; B60T 2250/04

(57) ABSTRACT

A method for operating a motor vehicle which has at least two axles, a braking system with at least four wheel brakes, which are arranged on a front axle and a rear axle, and which has a data processing device. A braking force distribution is specified by the data processing device. A front braking force component for the front wheel brakes and a rear braking force component for the rear wheel brakes are specified by the braking force distribution, and the braking force distribution is adapted to improve the NVH characteristics of the motor vehicle if it is determined by means of the data processing device that a specified condition is fulfilled for an acoustically perceptible release of a tension in the motor vehicle. The braking force distribution is adjusted by reducing the front braking force and increasing the rear braking force.

### FIELD

The invention relates to a method for operating a motor vehicle. The invention further relates to a motor vehicle and a computer program product.

### BACKGROUND

When parking a motor vehicle, steering maneuvers are typically carried out at low speed. These steering maneuvers can, for example, lead to tension in the chassis components (axle, control arms, brakes, tires) of the motor vehicle due to the axle geometry and the steering roll radius. This applies in particular when steering maneuvers are carried out while the vehicle is stationary and/or when steering maneuvers are carried out with the brakes applied. If the brake is then released and/or the vehicle is set in motion, the tension is reduced again. However, the reduction of tension often leads to a noise in the vehicle, which is usually perceived as disturbing.

### SUMMARY

The object of the present invention is to provide an advantageous method for operating a motor vehicle. Furthermore, it is an object of the present invention to provide an advantageously designed motor vehicle and an advantageous computer program product.

This object is achieved by a method, by a motor vehicle and by a computer program product. The advantages and preferred embodiments mentioned with regard to the method can also be transferred mutatis mutandis to the devices, i.e. the computer program product on the one hand and the motor vehicle on the other hand, and vice versa.

The method according to the invention serves to operate a motor vehicle according to the invention and, conversely, a motor vehicle according to the invention is designed to carry out the method according to the invention in at least one operating mode.

The motor vehicle according to the invention has at least two axles, namely a front axle and a rear axle. The front axle is preferably designed as a steered front axle and the rear axle is preferably designed as an integrated steering rear axle or as an unsteered rear axle. Furthermore, the motor vehicle, i.e. the motor vehicle according to the invention, has a braking system with at least four wheel brakes, namely with two front wheel brakes arranged on the front axle and with two rear wheel brakes arranged on the rear axle. In addition, the motor vehicle has a data processing device which is also designed in particular to control the braking system.

In the course of executing the method, i.e. the method according to the invention, a braking force distribution is now specified by means of the data processing device. The braking force distribution then specifies a front braking force component for the front wheel brakes and a rear braking force component for the rear wheel brakes. The braking force components, i.e. the front braking force component and the rear braking force component, determine the ratio in which the front wheel brakes and the rear wheel brakes contribute to the total braking force that is generated during a braking process by means of the wheel brakes of the braking system. In particular, the braking system is controlled or regulated in the braking system in such a way that a total braking force is generated on the basis of a braking request or as a function of a braking request. The total braking force is made up of the partial braking forces generated by the individual wheel brakes. The wheel brakes are controlled in such a way that the specified braking force distribution is implemented, with the front wheel brakes contributing to the total braking force in accordance with the front braking force component and the rear wheel brakes contributing to the total braking force in accordance with the rear braking force component.

Furthermore, in the course of the method, the braking force distribution is adjusted to improve the NVH characteristics of the motor vehicle if it is determined by means of the data processing device that a predetermined condition is fulfilled for an acoustically perceptible release of a tension in the motor vehicle. The braking force distribution is then adjusted based on a basic braking force distribution in such a way that the front braking force component is reduced and the rear braking force component is increased.

This will ensure that tensions in the motor vehicle, particularly tensions of the type mentioned above, occur less frequently and/or are less pronounced. Accordingly, the typical noises that are usually heard when releasing tension occur less frequently and/or are less pronounced, so that they are perceived as less disturbing. This improves the so-called NVH characteristics of the vehicle. NVH stands for Noise-Vibration-Harshness and refers to the acoustically and/or haptically perceptible vibrations that can occur in motor vehicles.

Preferably, the braking force distribution is adjusted independently of a braking request. It is therefore preferable to make an adjustment to the control system of the braking system, for example by adapting a control program. The adjustment takes place as soon as the specified condition is met. However, the generation of a total braking force taking into account the adjusted braking force distribution only occurs when a braking request is also generated, for example when a driver presses a brake pedal or when an assistance function generates a braking command, for example an assistance function that is designed to implement an autonomous driving function or a partially autonomous driving function.

Irrespective of this, in the course of the method the adjustment of the braking force distribution is preferably canceled if the data processing device determines that the specified condition is no longer met. The adjustment of the braking force distribution is therefore typically limited in time. It occurs whenever the specified condition is fulfilled and is canceled whenever the specified condition is no longer met.

Furthermore, it is useful if the braking force distribution only specifies basic values for the braking force components. Based on these basic values, the wheel brakes are then preferably controlled in such a way that deviations from the basic values are permitted, for example in order to implement an ABS system (anti-lock braking system) or a driving dynamics control system (ESC: Electronic Stability Control). Alternatively, the braking force components are fixed.

Irrespective of this, the specified condition consists of two or more sub-conditions depending on the application. In this case, the specified condition is only fulfilled when all specified sub-conditions are fulfilled.

Further advantageous is an embodiment of the method in which the predetermined condition or at least one of the sub-conditions is fulfilled when the speed of the motor vehicle is less than or equal to a predetermined limit value. Depending on the application, the limit value is preferably in a range between 10 km/h and 60 km/h, more preferably in a range between 20 km/h and 60 km/h and in particular in a range between 30 km/h and 60 km/h.

It is also useful to carry out the method such that the specified condition or at least one of the sub-conditions is fulfilled when a specified limit value for a steering lock or steering angle is exceeded.

A method variant is also preferred in which a trajectory for the motor vehicle is determined by means of the data processing device in at least one operating mode. In this case, the data processing device is then typically configured to implement an assistance function for autonomous vehicle guidance or for partially autonomous vehicle guidance, wherein the vehicle guidance in at least one operating mode is carried out by the assistance function on the basis of the determined trajectory.

In this case, the predetermined condition or at least one of the sub-conditions is then preferably fulfilled if an increase in the aforementioned trajectory is greater than or equal to a predetermined limit value.

According to a further embodiment variant, the predetermined condition or at least one of the sub-conditions is fulfilled if, alternatively or additionally, a curvature of the aforementioned trajectory is greater than or equal to a predetermined limit value.

In addition, an embodiment variant is advantageous in which the predetermined condition or at least one of the sub-conditions is fulfilled if, based on the previously mentioned trajectory, a temporary need for a steering angle greater than or equal to 15° and in particular greater than or equal to 20° is determined.

It is also useful to carry out the method in an embodiment in which the predetermined condition or at least one of the sub-conditions is fulfilled when an aforementioned assistance function is activated, for example a parking assistance function or a park steering assistance function.

A variant of the method is also advantageous in which a slope gradient, i.e. a gradient in the local terrain, is determined by means of the data processing device and in which the specified condition or at least one of the sub-conditions is fulfilled if the slope gradient is greater than or equal to a specified limit value. Depending on the application, the limit value for the slope gradient is in a range between 2% and 15%, more preferably in a range between 4% and 12% and in particular in a range between 6% and 10%.

It is also advantageous if the braking force distribution is adjusted depending on the speed of the motor vehicle by progressively reducing the front braking force component as the speed decreases and progressively increasing the rear braking force component as the speed decreases. This means that there is no simple switching back and forth between two different braking force distributions, but rather an increasing redistribution is carried out, with a redistribution then conveniently being carried out in the opposite direction as the speed of the vehicle increases.

Also preferred is a method variant in which the braking force distribution is adjusted such that the front braking force component is reduced up to 0% or to 0% and that the rear braking force component is increased up to 100% or to 100%. This means that the braking force distribution is adjusted in such a way that the front wheel brakes are not used, at least within a given speed range.

The braking force is then preferentially distributed to the rear axle, at least when braking is requested, and the front axle is not subjected to braking forces. In hydraulic braking systems, the braking force is distributed to the rear axle, for example, by closing inlet valves in the front axle brake lines. An existing brake pressure on the front axle can be reduced and relieved by opening the outlet valves as required and by draining brake fluid volume into the brake fluid reservoir. The reduced braking force on the front axle is compensated by an increase in the braking force on the rear axle, e.g. by increasing the braking pressure on the rear axle. In this state, the requested braking force is delivered entirely by the rear axle, as far as the coefficient of friction between the tires and the road allows. Otherwise, a redistribution to the installed braking force distribution, i.e. the basic braking force distribution, is carried out. Because the front wheels of the front axle are not braked in this state, they can roll freely during steering operations even when the vehicle is stationary, and this does not result in any tension that would otherwise be released by emitting a noticeable noise when the braking force is reduced.

The method according to the invention described above is intended for execution in a motor vehicle according to the invention or by a motor vehicle according to the invention. Conversely, a motor vehicle according to the invention is designed to carry out the corresponding method in at least one operating mode. The motor vehicle has a braking system as described above and a data processing device as described above. The data processing device is then preferably used to carry out the individual steps of the method or at least to carry out a number of steps of the method, wherein an executable program is preferably stored or installed in the data processing device for this purpose, which device automatically carries out the method or the number of steps of the method after a start.

A corresponding program can also be installed or stored subsequently by means of a computer program product according to the invention, provided that a suitable braking system and a suitable data processing device are already present in a motor vehicle. The computer program product is typically a file or a data storage device containing a file, wherein the file contains the executable program, in particular a suitable program code.

It is again pointed out that the advantages and preferred embodiments mentioned with regard to the method can also be transferred mutatis mutandis to the devices, i.e. the computer program product on the one hand and the motor vehicle on the other hand, and vice versa.

### BRIEF DESCRIPTION OF THE FIGURE(S)

Further advantages, features, and details of the invention result from the claims, the following description of preferred exemplary embodiments and on the basis of the schematic drawing. In particular:

FIG. 1 shows a motor vehicle in a block diagram.

### DETAILED DESCRIPTION

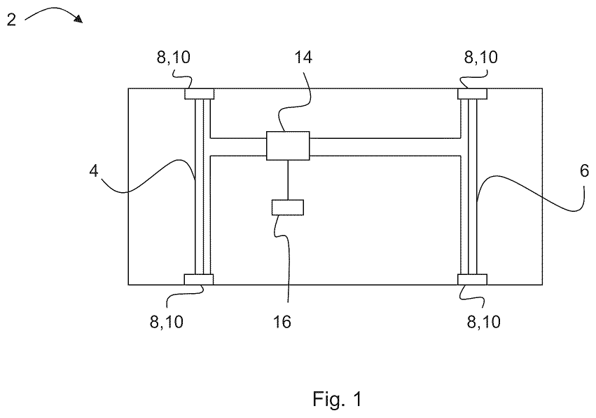

A motor vehicle 2 described below as an example and shown schematically in FIG. 1 has two axles 4, 6, namely a front axle 4 and a rear axle 6. The front axle 4 is designed as a steered front axle 4 and the rear axle 6 is designed as an unsteered rear axle 6.

Furthermore, the motor vehicle 2 has a braking system 8 with two front wheel brakes 10, which are arranged on the front axle 4, and with two rear wheel brakes 12, which are arranged on the rear axle 6.

In addition, the motor vehicle 2 has a data processing device 14, which is designed, among other things, to control the braking system 8, and a sensor device 16, which is connected to the data processing device 14 by means of signals. In the exemplary embodiment, the data processing device 14 is configured to carry out a method in at least one operating mode, which method is explained in more detail below.

In the course of executing this method, a braking force distribution is specified by means of the data processing device 14. The braking force distribution then specifies a front braking force component for the front wheel brakes 10 and a rear braking force component for the rear wheel brakes 12. The braking force components, i.e. the front braking force component and the rear braking force component, determine the ratio in which the front wheel brakes 10 and the rear wheel brakes 12 contribute to the total braking force that is generated during a braking process by means of the wheel brakes 10, 12 of the braking system 8.

Furthermore, in the course of the method, the braking force distribution is adjusted to improve the NVH characteristics of the motor vehicle 2 if it is determined by means of the data processing device 14 that a predetermined condition is fulfilled for an acoustically perceptible release of a tension in the motor vehicle 2. The braking force distribution is then adjusted based on a basic braking force distribution in such a way that the front braking force component is reduced and the rear braking force component is increased.

In the course of the method the adjustment of the braking force distribution is also canceled if the data processing device 14 determines that the specified condition is no longer fulfilled. The braking force distribution is therefore adjusted as required. This occurs whenever the specified condition is fulfilled and is undone whenever the specified condition is no longer fulfilled.

Also preferred is a method variant in which the braking force distribution is adjusted such that the front braking force component is reduced up to 0% or to 0% and that the rear braking force component is increased up to 100% or to 100%. This means that the braking force distribution is adjusted in such a way that the front wheel brakes 10 are not used, at least within a predetermined speed range.

In the exemplary embodiment, the predetermined condition is also fulfilled if the speed of the motor vehicle 2 is less than or equal to a predetermined limit value. The limit value is preferably in a range between 30 km/h and 60 km/h. The speed of the motor vehicle 2 is determined by means of the sensor device 16.

According to an alternative method variant, the data processing device 14 is configured to implement an assistance function for autonomous parking processes, i.e. a parking assistance function. When the assistance function is activated, the data processing device 14 determines a trajectory for the motor vehicle 2 on the basis of sensor data from the sensor device 16.

In this case, the predetermined condition is then further fulfilled if an increase in the aforementioned trajectory is greater than or equal to a predetermined limit value. According to a further embodiment variant, the predetermined condition is fulfilled if, alternatively or additionally to the gradient, a curvature of the trajectory is greater than or equal to a predetermined limit value.

### LIST OF REFERENCE NUMERALS

2 motor vehicle
4 front axle
6 rear axle
8 braking system
10 front wheel brake
12 rear wheel brake
14 data processing device
16 sensor device

1-10. (canceled)

11. A method for operating a motor vehicle which has at least two axles, namely a front axle and a rear axle, which has a braking system with at least four wheel brakes, namely two front wheel brakes arranged on the front axle and two rear wheel brakes arranged on the rear axle, and which has a data processing device,
wherein
a braking force distribution is specified by the data processing device,
the braking force distribution specifies a front braking force component for the front wheel brakes and a rear braking force component for the rear wheel brakes,
the braking force distribution is adjusted to improve the Noise-Vibration-Harshness (NVH) characteristics of the motor vehicle if it is determined by the data processing device that a predetermined condition is fulfilled for an acoustically perceptible release of a tension in the motor vehicle, and
the braking force distribution is adjusted by reducing the front braking force component and by increasing the rear braking force component.

12. The method according to claim 11, wherein the braking force distribution is adjusted independently of a braking request.

13. The method according to claim 11, wherein the predetermined condition is fulfilled if the speed of the motor vehicle is less than or equal to a predetermined limit value which lies in a range between 15 km/h and 60 km/h.

14. The method according to claim 11, wherein a trajectory for the motor vehicle is determined by the data processing device, and wherein the predetermined condition is fulfilled if a gradient of the trajectory is greater than or equal to a predetermined limit value.

15. The method according to claim 11, wherein a trajectory for the motor vehicle is determined by the data processing device, and wherein the predetermined condition is fulfilled if a curvature of the trajectory is greater than or equal to a predetermined limit value.

16. The method according to claim 11, wherein a slope in the local terrain is determined by the data processing device and wherein the predetermined condition is fulfilled if the slope is greater than or equal to a predetermined limit value.

17. The method according to claim 11, wherein the braking force distribution is adjusted depending on the speed of the motor vehicle by progressively reducing the front braking force component as the speed decreases and progressively increasing the rear braking force component as the speed decreases.

18. The method according to claim 11, wherein the braking force distribution is adjusted by reducing the front braking force component to 0% and by increasing the rear braking force component to 100%.

19. A motor vehicle, configured to carry out a method according to claim 11 in at least one operating mode.

20. A computer program product containing a program executable on a data processing device which, after being started, automatically executes a method according to claim 11.

21. The method according to claim 12, wherein the predetermined condition is fulfilled if the speed of the motor vehicle is less than or equal to a predetermined limit value which lies in a range between 15 km/h and 60 km/h.

22. The method according to claim 12, wherein a trajectory for the motor vehicle is determined by the data processing device, and wherein the predetermined condition is fulfilled if a gradient of the trajectory is greater than or equal to a predetermined limit value.

23. The method according to claim 13, wherein a trajectory for the motor vehicle is determined by the data processing device, and wherein the predetermined condition is fulfilled if a gradient of the trajectory is greater than or equal to a predetermined limit value.

24. The method according to claim 12, wherein a trajectory for the motor vehicle is determined by the data processing device, and wherein the predetermined condition is fulfilled if a curvature of the trajectory is greater than or equal to a predetermined limit value.

25. The method according to claim 13, wherein a trajectory for the motor vehicle is determined by the data processing device, and wherein the predetermined condition is fulfilled if a curvature of the trajectory is greater than or equal to a predetermined limit value.

26. The method according to claim 14, wherein a trajectory for the motor vehicle is determined by the data processing device, and wherein the predetermined condition is fulfilled if a curvature of the trajectory is greater than or equal to a predetermined limit value.

27. The method according to claim 12, wherein a slope in the local terrain is determined by the data processing device and wherein the predetermined condition is fulfilled if the slope is greater than or equal to a predetermined limit value.

28. The method according to claim 13, wherein a slope in the local terrain is determined by the data processing device and wherein the predetermined condition is fulfilled if the slope is greater than or equal to a predetermined limit value.

29. The method according to claim 14, wherein a slope in the local terrain is determined by the data processing device and wherein the predetermined condition is fulfilled if the slope is greater than or equal to a predetermined limit value.

30. The method according to claim 15, wherein a slope in the local terrain is determined by the data processing device and wherein the predetermined condition is fulfilled if the slope is greater than or equal to a predetermined limit value.
